(19) United States
(12) Patent Application Publication
(10) Pub. No.: US 2025/0369079 A1
(43) Pub. Date: Dec. 4, 2025

(54) ALLOY MEMBER, BONDED BODY, APPARATUS, METHOD FOR MANUFACTURING ALLOY MEMBER, AND METHOD FOR MANUFACTURING BONDED BODY

(71) Applicant: CANON KABUSHIKI KAISHA, Tokyo (JP)

(72) Inventors: HIROTOMO TAMIYA, Kanagawa (JP); JUN-ICHI SAKAMOTO, Kanagawa (JP)

(21) Appl. No.: 19/217,843

(22) Filed: May 23, 2025

(30) Foreign Application Priority Data
May 28, 2024 (JP) 2024-086421

(51) Int. Cl. C22C 23/02; B32B 15/08; C25D 11/30

(52) U.S. Cl. CPC C22C 23/02; B32B 15/08; C25D 11/30; B32B 2250/02; B32B 2311/00

(57) ABSTRACT

An alloy member includes a base containing magnesium and lithium, and an anti-corrosion film disposed on the base, the anti-corrosion film containing magnesium, phosphorus, and fluorine. The anti-corrosion film includes at least one first recess in a surface on a side opposite the base. A surface of the at least one first recess includes at least one second recess smaller than the at least one first recess.

### BACKGROUND

### Technical Field

The present invention relates to an alloy member containing magnesium and lithium, a bonded body, an apparatus, a method for manufacturing an alloy member, and a method for manufacturing a bonded body.

### Description of the Related Art

Magnesium-lithium alloys containing magnesium and lithium are used in various products because of their light weight and excellent mechanical strength. For products where a weight reduction is demanded, it is known to avoid screw fastening and instead bond two members via a bonding resin that is a cured adhesive.

It is known, however, that when an alloy member made of a magnesium-containing alloy is bonded to another member using a bonding resin, a fragile layer is formed at the interface between the alloy member and the bonding resin and the desired adhesive strength is unattainable. Japanese Patent Application Laid-Open No. 2007-308757 discusses a technique for improving the adhesive strength by forming a porous magnesium oxide layer on the surface of an alloy consisting mainly of magnesium by a micro arc oxidation treatment, which is one of anodization treatments.

According to the method discussed in Japanese Patent Application Laid-Open No. 2007-308757, the adhesion of the bonding resin, a cured adhesive, has sometimes been insufficient since the pore size of the porous layer is unable to be made sufficiently large. A resin coating formed by curing a resin material on this alloy has sometimes peeled off.

### SUMMARY

According to a first aspect of the present disclosure, an alloy member includes a base containing magnesium and lithium, and an anti-corrosion film disposed on the base, the anti-corrosion film containing magnesium, phosphorus, and fluorine, wherein the anti-corrosion film includes at least one first recess in a surface on a side opposite the base, and wherein a surface of the first recess includes at least one second recess smaller than the first recess.

According to a second aspect of the present disclosure, a bonded body includes the alloy member, a member to be bonded, and a bonding resin configured to bond the alloy member and the member to be bonded, wherein a part of the bonding resin is located in the first recess and the second recess.

According to a third aspect of the present disclosure, a method for manufacturing an alloy member includes placing an anode and a cathode in an electrolyte solution, and applying a voltage across the anode and the cathode to form an anti-corrosion film on the anode, wherein the anode contains magnesium and lithium, wherein the electrolyte solution contains fluorine, ammonium, and phosphorus, and wherein a content ratio of fluorine ions to a total amount of phosphate ions and fluorine ions in the electrolyte solution is in a range of 88% or more and 99.5% or less.

According to a fourth aspect of the present disclosure, a method for manufacturing a bonded body for bonding an alloy member and a member to be bonded via an adhesive includes preparing the alloy member using the above-described method for manufacturing the alloy member, placing the adhesive on the alloy member and/or the member to be bonded, and curing the adhesive to form a bonding resin configured to bond the alloy member and the member to be bonded.

Further features of the present disclosure will become apparent from the following description of exemplary embodiments with reference to the attached drawings.

### BRIEF DESCRIPTION OF THE DRAWINGS

FIG. 1 is a schematic diagram illustrating a bonded body according to a first exemplary embodiment.

FIG. 2A is a 50× scanning electron microscope (SEM) image of the surface of an anti-corrosion film according to the first exemplary embodiment. FIG. 2B is a 500× SEM image of the surface of the anti-corrosion film according to the first exemplary embodiment.

FIG. 3 is a schematic diagram for describing a first normal and a second normal according to the first exemplary embodiment.

FIG. 4 is a flowchart illustrating manufacturing steps of the bonded body according to the first exemplary embodiment.

FIG. 5 is a schematic diagram illustrating an anodization apparatus for manufacturing an alloy member of the bonded body according to the first exemplary embodiment.

FIG. 6A is a schematic diagram illustrating a radiographic apparatus that is a modification of the first exemplary embodiment. FIG. 6B is a schematic diagram illustrating the radiographic apparatus that is the modification of the first exemplary embodiment.

FIG. 7 is a schematic diagram illustrating cross section I-I of the radiographic apparatus illustrated in FIG. 6B.

FIG. 8 is a schematic diagram illustrating an alloy member according to a second exemplary embodiment.

FIG. 9 is a schematic diagram illustrating an optical device and an imaging apparatus that are a modification of the second exemplary embodiment.

FIG. 10 is a schematic diagram illustrating an adhesion force evaluation method of practical examples and comparative examples.

FIGS. 11A to 11F are SEM with energy-dispersive X-ray spectroscopy (SEM-EDS) images of the vicinity of a central part of an anti-corrosion film according to example 2 in a thickness direction, observed from the surface.

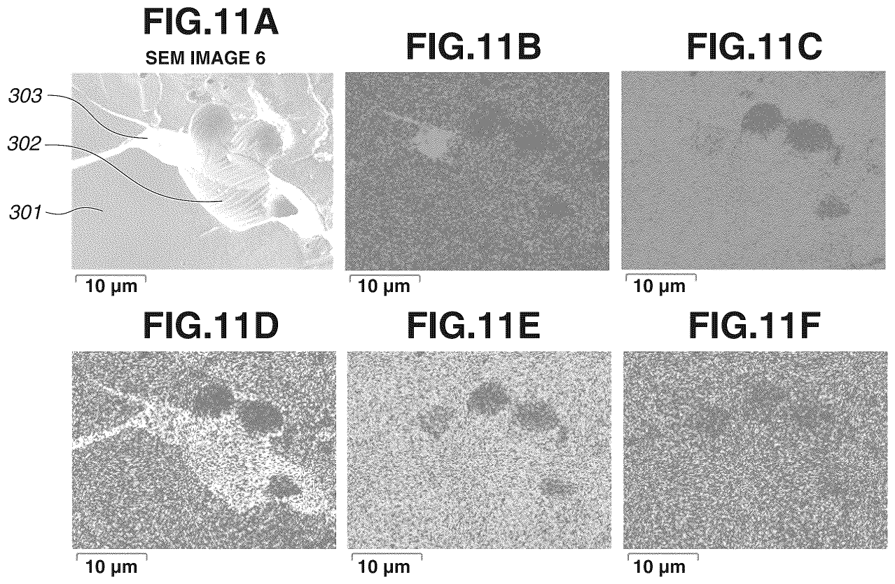

### DESCRIPTION OF THE EMBODIMENTS

Exemplary embodiments for carrying out the present disclosure will be described in detail with reference to the drawings.

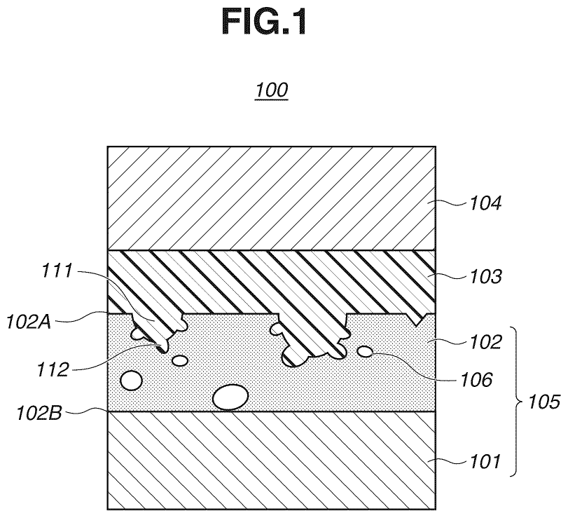

FIG. 1 is a schematic diagram illustrating a bonded body according to a first exemplary embodiment, illustrating a cross section taken along a stacking direction. A bonded body 100 includes a base 101, an anti-corrosion film 102 disposed on the base 101, a bonding resin 103 that is a cured adhesive disposed on the anti-corrosion film 102, and a member to be bonded 104. In the first exemplary embodiment, the base 101 with the anti-corrosion film 102 disposed thereon will be referred to as an alloy member 105. The bonded body 100 according to the present exemplary embodiment is not limited to any particular application, and can be used as a structure based on the user's intended use. Examples include exterior members (housings), interior members, and sliding members of equipment having parts.

### (Base)

The base 101 is made of an alloy containing magnesium and lithium, and desirably made of a magnesium-lithium alloy (hereinafter, Mg—Li alloy) with magnesium as a main component and containing lithium. As employed herein, the main component, when an item is composed of a plurality of elements, refers to the element with the largest total mass among the elements contained. When the item is composed of a plurality of compounds, the main component refers to the compound with the largest total mass among the compounds contained.

Of Mg—Li alloys, those with a total content of magnesium (Mg) and lithium (Li) of 90 mass % or more are desirable for use as the base 101. The alloys with the total content of magnesium and lithium of 90 mass % or more are lighter than lithium-free magnesium alloys. Mg—Li alloys also have excellent damping properties and specific strength compared to lithium-free magnesium alloys. Excellent damping properties mean that the material quickly converts vibration energy into thermal energy, whereby vibrations are attenuated in a short time. Specific strength refers to tensile strength per unit density. The higher the specific strength, the lighter the member can be made.

The Mg—Li alloy may contain aluminum (Al) and zinc (Zn) aside from magnesium and lithium, and may even contain germanium (Ge) and/or beryllium (Be). In addition to the foregoing elements, the Mg—Li alloy can contain at least one element selected from a group consisting of zirconium (Zr), calcium (Ca), silicon (Si) and manganese (Mn), with the remainder being incidental impurities and magnesium.

Examples of the incidental impurities include iron (Fe), copper (Cu), cobalt (Co), and nickel (Ni).

The lithium (Li) content of the Mg—Li alloy is desirably in the range of 0.5 mass % or more and 15 mass % or less. With an Li content of less than 0.5 mass %, the Mg—Li alloy can be difficult to make lighter than magnesium alloys. With an Li content of more than 15 mass %, the Mg—Li alloy may not have sufficient damping properties. The desirable range is 5 mass % or more and 11 mass % or less, where the a phase and β phase coexist. Within this range, the base 101 has high corrosion resistance and mechanical strength and is thus suitable as a structural material.

The aluminum (Al) content of the Mg—Li alloy is desirably in the range of 1 mass % or more and 8 mass % or less. Al plays the role of improving the fracture strength of the base 101. The Al content within the foregoing range can provide sufficient mechanical strength compared to without Al. The 1 reason is considered to be that Al reacts with Mg and/or Li to precipitate compounds such as Al—Li, Mg—Al, and Mg—Li—Al compounds, whereby the mechanical strength is improved. The content is more desirably in the range of 3 mass % or more and 7 mass % or less.

The total content of germanium (Ge) and beryllium (Be) in the Mg—Li alloy is desirably in the range of 0.02 mass % or more and 0.4 mass % or less. Ge and Be partially substitute for Al and play the role of improving the corrosion resistance of the base 101. As described above, Mg—Li alloys containing Al have improved mechanical strength because of the reaction of Al with Mg and/or Li. Li-rich grain boundaries segregate in the matrix phase during the process, and makes the alloys more susceptible to corrosion. However, partially substituting Al with elements having smaller atomic radii like Ge and Be can preferentially arrange Ge and Be at grain boundaries instead of Li, and suppress the segregation of Li at grain boundaries. This can improve corrosion resistance. The content of Ge alone is desirably in the range of 0.01 mass % or more and 0.4 mass % or less, more desirably in the range of 0.01 mass % or more and 0.2 mass % or less. The content of Be alone is desirably in the range of 0.02 mass % or more and 0.1 mass % or less, more desirably in the range of 0.02% or more and 0.05% or less.

The zirconium (Zr) content of the Mg—Li alloy is desirably in the range of 0.6 mass % or more and 3.0 mass % or less. The reason is that the grain size can thereby be prevented from coarsening during the solidification process from the liquid phase to the solid phase in manufacturing the base 101.

Zirconium (Zr), calcium (Ca), silicon (Si), and manganese (Mn) in the Mg—Li alloy play the role of improving the strength of the base 101. The total content of these elements is desirably in the range of 0.01 mass % or more and 5 mass % or less. The Zn content is desirably 3 mass % or less. A more desirable range is 0.1 mass % or more and 2 mass % or less. The Ca content is desirably 3 mass % or less. A more desirable range is 0.1 mass % or more and 1.0 mass % or less. The Si content is desirably 0.2 mass % or less. A more desirable range is 0.1 mass % or more and 0.2 mass % or less. The Mn content is desirably 0.5 mass % or less. A more desirable range is 0.1 mass % or more and 0.2 mass % or less.

The base 101 may contain metal elements other than those mentioned above, within a range that does not cause variations in properties. Such metal elements include incidental impurities that are inevitably included during manufacturing. Examples of the incidental impurities include Fe, Cu, Co, and Ni. The content of each of such elements is 0.1 mass % or less. The total content of the incidental impurities is 1 mass % or less.

The materials of the Mg—Li alloy are not limited in particular. Examples of commercially available materials include LZ91, LAZ771, LAZ941, and Ares manufactured by Amli Materials Technology Co., Ltd.

The thickness of the base 101 is not limited in particular. In view of sufficient rigidity, the base 101 desirably has a thickness greater than that of the anti-corrosion film 102.

### (Anti-Corrosion Film)

The anti-corrosion film 102 is disposed on the base 101. The anti-corrosion film 102 contains magnesium (Mg), phosphorus (P), fluorine (F), and oxygen (O). The anti-corrosion film 102 desirably contains lithium (Li) as well. The anti-corrosion film 102 desirably has an average thickness of 20 μm or greater, more desirably greater than 20 μm. The reason is that the bonded body 100 can be prevented from diffusion and permeation of water up to the interface between the anti-corrosion film 102 and the base 101 over a long period of time. This can reduce the possibility of water reaching the base 101 even if the water permeates through the surface of the anti-corrosion film 102.

The anti-corrosion film 102 includes two surfaces. One is a surface 102B contacting the base 101. The other is a surface 102A contacting the bonding resin 103. In other words, the surface 102A is the surface located on the side opposite the base 101. The anti-corrosion film 102 is a porous body including a plurality of pores 106.

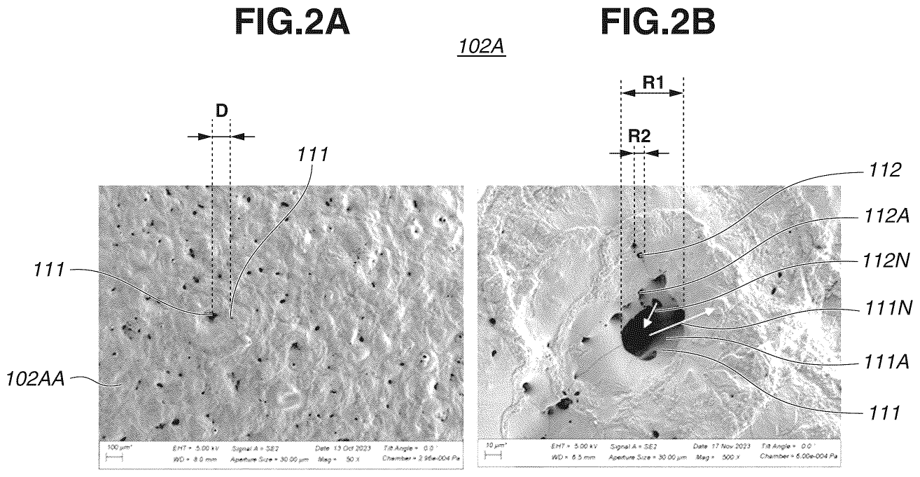

FIGS. 2A and 2B are scanning electron microscope (SEM) images of the surface 102A of the anti-corrosion film 102. FIG. 2A is an image at a magnification of 50 times. FIG. 2B is an image at a magnification of 500 times.

The surface 102A of the anti-corrosion film 102 includes at least one first recess 111. A surface 111A of the first recess 111 includes at least one second recess 112 that is smaller than the first recess 111 in size. The second recess 112 may be a through hole.

Disposing a part of the bonding resin 103 in the first recesses 111 and the second recesses 112 enhances adhesion between the anti-corrosion film 102 and the bonding resin 103. This makes the bonding strength between the alloy member 105 and the member to be bonded 104 sufficient. The reason is that the adhesive that is the precursor of the bonding resin 103 is disposed on the anti-corrosion film 102 in bonding the alloy member 105 and the member to be bonded 104, and the adhesive thus enters the first recesses 111 and the second recesses 112 and cures there. In other words, the bonding resin 103 is in contact with a non-recess region 102AA of the surface 102A, the surfaces 111A of the first recesses 111, and surfaces 112A of the second recesses 112. Since the bonded body 100 has the second recesses 112, the contact area between the anti-corrosion film 102 and the bonding resin 103 increases as compared to without the second recesses 112. The adhesion between the anti-corrosion film 102 and the bonding resin 103 is thus higher than with a bonded body 100 without the second recesses 112.

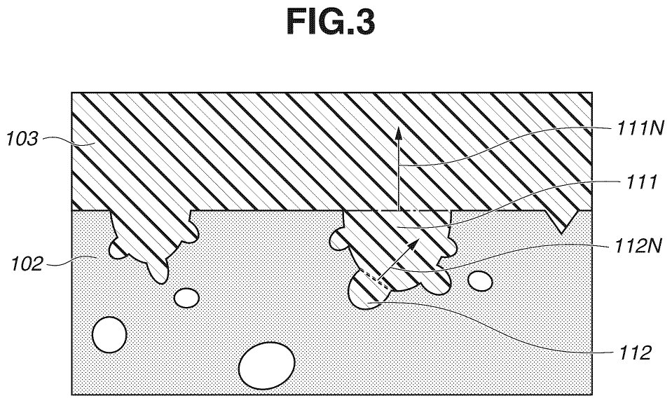

In view of enhancing the adhesion between the anti-corrosion film 102 and the bonding resin 103, the first recesses 111 and the second recesses 112 are desirably formed in different directions. More specifically, as illustrated in FIG. 3, the direction of a first normal 111N that is a line perpendicular to an imaginary plane filling a first recess 111 desirably intersects with the direction of a second normal 112N that is a line perpendicular to an imagery plane filling a second recess 112. With the directions of the two normals in the foregoing relationship, the protrusion of the bonding resin 103 located in the second recess 112 of the bonding resin 103 is less likely to come off even when external force acts in a direction in which the bonding resin 103 comes off the first recess 111 (the direction of the normal 111N) easily, since the direction differs from that in which the bonding resin 103 comes off the second recess 112 (the direction of the normal 112N) easily. This provides an enhanced anchor effect.

The first recesses 111 desirably have an average equivalent circle diameter R1 of 30 μm or greater, more desirably greater than 30 μm. The average equivalent circle diameter R1 can be measured using an SEM image, for example. This image is a plan view of the surface 102A with respect to the non-recess region 102AA. In other words, the average equivalent circle diameter R1 of the first recesses 111 is the size of the first recesses 111 that can be measured in the plan view of the surface 102A with respect to the region 102AA.

To make the average equivalent circle diameter R1 of the first recesses 111 greater than 30 μm, the content ratio of fluorine ions in an anodization treatment to be described below needs to be set to a predetermined condition. This condition will be described below in a manufacturing method section.

A distance D between adjacent first recesses 111 on the surface 102A is desirably greater than the average equivalent circle diameter R1 of the first recesses 111. The reason is that the region 102AA of sufficiently large area can facilitate enhancing the bonding strength between the alloy member 105 and the member to be bonded 104. The strength of the anti-corrosion film 102 itself can thus be easily made sufficient.

The ratio of presence (distribution density) of the first recesses 111 on the surface 102A is desirably in the range of 5/mm² or more and 50/mm² or less, more desirably 10/mm² or more. If the ratio of presence of the first recesses 111 is too high, the strength of the anti-corrosion film 102 itself becomes insufficient. Breakage can occur under a small force, and sufficient bonding strength may not be obtained. On the other hand, if the ratio of presence is too low, the contact area with the bonding resin 103 becomes so small that the foregoing anchor effect may not be much developed.

The second recesses 112 desirably have an average equivalent circle diameter R2 of 10 μm or less, more desirably less than 10 μm. The average equivalent circle diameter R2 can be measured using an SEM image, for example. This image is a plan view of the surface 102A with respect to the non-recess region 102AA. In other words, the average equivalent circle diameter R2 of the second recesses 112 is the size of the second recesses 112 that can be measured in the plan view of the surface 102A with respect to the region 102AA.

The surface 111A of each first recess 111 desirably includes 5 or more and 100 or less second recesses 112. The reason is that the bonding strength between the alloy member 105 and the member to be bonded 104 is enhanced by increasing the number of protrusions of the bonding resin 103 located in the second recesses 112.

The content ratio of fluorine at the surfaces 111A of the first recesses 111 and the surfaces 112A of the second recesses 112 is desirably higher than in the non-recess region 112AA of the surface 102A of the anti-corrosion film 102. If the content ratio of fluorine at the surfaces 111A of the first recesses 111 and the surfaces 112A of the second recesses 112 is higher than in the region 102AA, the uncured adhesive is preferentially taken into the surfaces 111A and 112A over the region 102AA. This increases the amount of adhesive entering the first recesses 111 and the second recesses 112, as compared to a case where the content ratio of fluorine at the surfaces 111A of the first recesses 111 and the surfaces 112A of the second recesses 112 is lower than or equal to that in the region 102AA.

The anti-corrosion film 102 is presumed to contain phosphorus in the form of magnesium phosphate compounds. If there is a lot of magnesium phosphate in the lithium-containing base 101 near the interface between the base 101 and the anti-corrosion film 102 (close to the surface 102B), oxygen in the magnesium phosphate and lithium in the base 101 can react to form lithium oxide (Li₂O). This lithium oxide is highly reactive with water and may degrade the durability of the bonded body 100 under high-temperature high-humidity environment. The magnesium phosphate therefore desirably exists more abundantly on the surface 102A of the anti-corrosion film 102.

The fluorine concentration in a region of the anti-corrosion film 102 close to the base 101 (close to surface 102B) is desirably higher than in a region of the anti-corrosion film 102 far from the base 101 (close to surface 102A side). This means that, in the anti-corrosion film 102, the content of inorganic fluoride near the base 101 is high and the content of inorganic oxide is low. If there is a lot of inorganic oxide in the region including the interface between the base 101 and the anti-corrosion film 102, oxygen and lithium may react to form lithium oxide. The type of inorganic fluoride is not limited in particular. Magnesium fluoride (MgF₂) where magnesium and fluorine can exist stably is desirably present as a main component. If there is a lot of magnesium fluoride in the region including the interface between the base 101 and the anti-corrosion film 102, fluorine in the magnesium fluoride and lithium can react to form lithium fluoride (LiF). Lithium fluoride, however, is stable toward water. The durability is therefore less likely to be impaired. The anti-corrosion film 102 therefore desirably has a higher magnesium fluoride concentration in the vicinity of the base 101.

### (Bonding Resin)

The bonding resin 103 is a cured adhesive, and plays the role of bonding the alloy member 105 and the member to be bonded 104.

The material of the bonding resin 103 is not limited in particular. For example, a solvent-free adhesive using urethane resin or epoxy resin can be used. The adhesive that is the precursor of the bonding resin 103 has a viscosity in the range of 5 Pa·s or more and 100 Pa·s or less. Even such a high-viscosity adhesive can develop the foregoing anchor effect if the first recesses 111 are greater than 30 μm.

The bonding resin 103 desirably has an elastic modulus in the range of 0.1 GPa or more and 15 GPa or less. The elastic modulus in this range absorbs impact and makes the alloy member 105 and the member to be bonded 104 less like to exfoliate from each other even when the bonded body 100 falls. A more desirable range is 0.2 GPa or more and 5 GPa or less.

The bonding resin 103 desirably has a thickness in the range of 3 μm or more and 150 μm or less. Such a thickness absorbs impact and makes the alloy member 105 and the member to be bonded 104 less likely to exfoliate from each other even when the bonded body 100 falls. A more desirable range is 5 μm or more and 50 μm or less.

### (Member to Be Bonded)

The member to be bonded 104 is a member to be bonded to the alloy member 105 via the bonding resin 103. The member to be bonded 104 is desirably made of lightweight material. Examples may include carbon fiber-reinforced plastic (CFRP), caron, polyvinyl chloride, acrylic resin, polyester, and polymethyl methacrylate resin (PMMA). Metal materials such as Mg—Li alloys, Mg alloys, and Al alloys can also be used.

The bonded body 100 according to the present disclosure includes the second recesses 112 smaller than the first recesses 111 in the surfaces of the first recesses 111 of the anti-corrosion film 102. A part of the bonding resin 103 is located in the first recesses 111 and the second recesses 112. The present disclosure can thereby provide a bonded body 100 having excellent adhesion between the anti-corrosion film 102 and the bonding resin 103 compared to heretofore.

### <Manufacturing Method According to First Exemplary Embodiment>

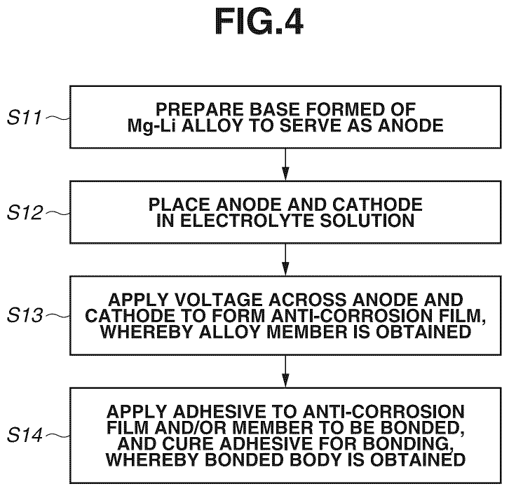

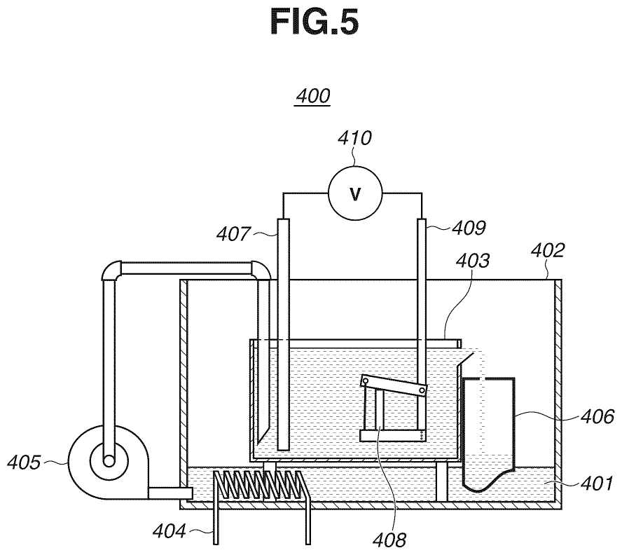

A method for manufacturing the bonded body 100 according to the present disclosure will be described with reference to FIGS. 4 and 5. FIG. 4 is a flowchart illustrating manufacturing steps of the bonded body 100. FIG. 5 is a schematic diagram illustrating an anodization apparatus for performing an anodization treatment.

In step S11, the base 101 made of Mg—Li alloy to serve as an anode is prepared. The method for manufacturing the base 101 is not limited in particular. Examples include casting, thixomolding, and die casting. Using such means for obtaining a molded article by rapidly cooling molten metal in a mold, a base of complicated shape or small thickness can be obtained inexpensively and safely. After the rapid cooling in the mold, the molded article may be secondarily machined by cutting, or the like, to obtain the base 101. Examples of the means other than the foregoing include machining an article shaped by forging or rolling.

In step S12, an anode and a cathode are placed in an electrolyte solution. An electrolyte solution 401 for use in the anodization is first prepared. The electrolyte solution is a liquid containing fluorine, ammonium, and phosphorus. Examples of fluorine- and ammonium-containing substances that can be used include acidic ammonium fluoride, neutral ammonium fluoride, and ammonia. Examples of phosphorus-containing substances that can be used include phosphoric acid and ammonium phosphate.

The content ratio of fluorine ions to the total amount of phosphate ions and fluorine ions in the electrolyte solution is in the range of 80% or more and 99.5% or less. This range has been found as a result of intensive study by the inventor. Setting the content ratio of fluorine ions within this range enables formation of the first recesses 111 and the second recesses 112. It has been found that within this range, the average equivalent circle diameter R1 of the first recesses 111 can be easily made greater than 30 μm, and the ratio of presence of the first recesses 111 can be easily adjusted to 5/mm² or more. A more desirable range is 85% or more and 99.5% or less. A yet more desirable range is 89% or more and 99.2% or less.

The concentration of ammonium ions in the electrolyte solution is desirably in the range of 6 mol/L or more and 12 mol/L or less. Setting the ammonium ion concentration within this range enables development of the film deposition reaction at low voltage compared to when the range is exceeded. More specifically, a low-resistance film can be formed from the initial stage of growth of the anti-corrosion film 102, and a film of uniform thickness can thus be obtained even if the thickness is greater than 20 μm. By contrast, outside the foregoing range, high-resistance portions are formed from the initial stage of film growth, and the potential difference within the film can be nonuniform. The high-resistance portions are difficult to increase the film thickness thereon, which may lead to uneven film thickness and can cause poor corrosion resistance and appearance defects. A more desirable range of the ammonium ion concentration is 6.5 mol/L or more and 11 mol/L or less.

The anodization apparatus 400 for forming an anodization film includes an outer tank 402 where the electrolyte solution is held and adjusted in temperature, and an inner tank 403 where electrical reaction takes place. The outer tank 402 includes a temperature adjustment mechanism 404, whereby the electrolyte solution is maintained at constant temperature. The solution temperature can be set within a range from low temperatures where the components do not coagulate to high temperatures where the components do not decompose. The optimum setting temperature is approximately 25°, where not much energy is needed for solution temperature adjustment. While the anodization apparatus 400 is described to be a two-tank apparatus, a one-tank apparatus may be used.

The outer tank 402 and the inner tank 403 are connected by a magnet pump 405 to circulate the electrolyte solution. In forming the anti-corrosion film 102, it is important to replace the electrolyte solution at the surface of the Mg—Li alloy. Since the anodization reaction is an exothermic reaction, the electrolyte solution at the surface causes self-convection for active solution replacement. The circulation of the electrolyte solution by the magnet pump 405 is therefore intended to remove byproducts produced in the electrolyte solution rather than for solution replacement at the surface. The anodization at the surface of the Mg—Li alloy forms a film, and lithium in the anode is discharged into the solution as ions. The discharged lithium ions react with fluorine ions and phosphate ions that are components of the electrolyte solution to produce slightly soluble salts. The slightly soluble salts may remain suspended as fine particles in the solution and make the electrolyte solution cloudy. To remove the fine particles produced in the solution, a bag filter 406 is disposed at the solution outlet of the inner tank 403. The bag filter 406 is desirably capable of moving fine particles of 10 μm and greater. A filter may also be installed in the piping system connected to the magnet pump 405.

An energization circuit capable of forming the anti-corrosion film 102 is then formed. A carbon electrode 407 to function as a cathode is installed in the inner tank 403. The cathode material is not limited in particular, as long as the electrolyte solution can be stably energized. Examples may include platinum, stainless steel, and titanium.

The base 101 made of Mg—Li alloy is clamped in a conductive holding jig 409 and set as an anode 408. The surface of the anode 408 has a natural oxide film, which does not need to be removed in advance since it will be replaced by a fluoride film or phosphate film in the anodization step. If the anode is cut or otherwise machined and there is oil stain adhering to the surface, the anode needs to be subjected to a pre-cleaning process, or the like, to remove the oil stain.

The conductive holding jig 409 is made of a metal having a higher anodization voltage than that of the anode 408 targeted for the anodization, and previously anodized at a high voltage. Examples of the material that can be used may include, but not limited to, pure Mg, Az31, and Az91.

The conductive holding jig 409 clamping the anode 408 and the carbon electrode 407 are connected by wires to a direct-current stabilized power supply 410 as an anode and a cathode, respectively. The anode conductive holding jig 409 connected by the wire is then immersed into the inner tank 403 to establish an anodized film formation circuit.

In step S13, a voltage is applied across the anode and cathode to form the anti-corrosion film 102, whereby the alloy member 105 is obtained. The direct-current stabilized power supply 410 is powered on to advance the anodization reaction. For the direct-current stabilized power supply 410, one designed to set a maximum current value and not pass a higher current is used. During the formation of the anodized film, the electric resistance at the surface of the Mg—Li alloy increases with the growth of the anti-corrosion film 102, and the voltage increases accordingly. The temperature of the electrolyte solution is maintained constant by the function of the temperature adjustment mechanism 404 accompanying the anodization apparatus 400.

The timing to stop the current is determined based on a cumulative current value passed through the Mg—Li alloy. As a specific example, the amount of electricity required to grow a film by 1 μm is 43.5 C per 100 cm². For example, in forming a 40-μm-thick anti-corrosion film on an Mg—Li alloy anode with a surface area of 100 cm², the direct-current stabilized power supply 410 is powered off when the energization of 1741 C (=43.5×40) is completed.

The setting value of the current can be determined based on the surface area of the anode and the current density. For example, to anodize a 100-cm² anode surface at a current density of 5 A/100 cm², the set current is 5 A. At low current densities, the anodization treatment takes long with a drop in productivity. At high current densities, the anodization treatment time decreases with an improvement in productivity. However, if the current density is too high, the anodized film grows with dielectric breakdown, which can deteriorate durability. A desirable range of the current density is thus from 1 A/100 cm² to 10 A/100 cm². In such a manner, the alloy member 105 including the base 101 on which the anti-corrosion film 102 is disposed can be obtained.

In step S14, an adhesive is applied to the anti-corrosion film 102 of the alloy member 105 and/or the member to be bonded 104, and cured for bonding, whereby the bonded body 100 is obtained. The adhesive is desirably applied to wet and spread over the entire surface 102A of the anti-corrosion film 102. In other words, the adhesive is desirably applied to wet and spread over the first recesses 111, the second recesses 112, and the non-recess region 102AA of the anti-corrosion film 102. When cured, the adhesive becomes the bonding resin 103. The type of adhesive is not limited in particular. For example, solvent-free adhesives using urethane resin or epoxy resin can be used. In such a case, the adhesive has a viscosity in the range of 5 Pa·s or more and 100 Pa·s or less. Even such a high-viscosity adhesive can develop the foregoing anchor effect if the first recesses 111 are greater than 30 μm. The method for applying the adhesive is not limited in particular. When a two-component adhesive is used, predetermined amounts of components are desirably applied using a dispenser. The member to be bonded 104 is laminated on the surface of the anti-corrosion film 102 where the adhesive is applied. After the lamination, the member to be bonded 104 is lightly pressed so that the adhesive adheres closely to the adhesive surface where the adhesive is applied. Finally, the adhesive is cured, whereby the bonded body 100 according to the present exemplary embodiment can be obtained. Depending on the type of adhesive, the bonded body 100 is stored in a 60° C. environment for 30 minutes or left to stand still at room temperature for half a day or more for complete curing.

The method for manufacturing the bonded body 100 according to the present exemplary embodiment uses an electrolyte solution where the content ratio of fluorine ions to the total amount of phosphate ions and fluorine ions is 88% or more and 99.5% or less during the anodization treatment on the alloy base 101. This can form the first recesses 111 and second recesses 112 in the anti-corrosion film 102. Since the alloy member 105 including such an anti-corrosion film 102 and the member to be bonded 104 are bonded via the adhesive, a bonded body 100 with higher adhesive strength than heretofore can be provided.

An example where the bonded body 100 according to the first exemplary embodiment is applied to an apparatus will be described. While a radiographic apparatus is described below as an example, the apparatus is not limited thereto.

### [Radiographic Apparatus]

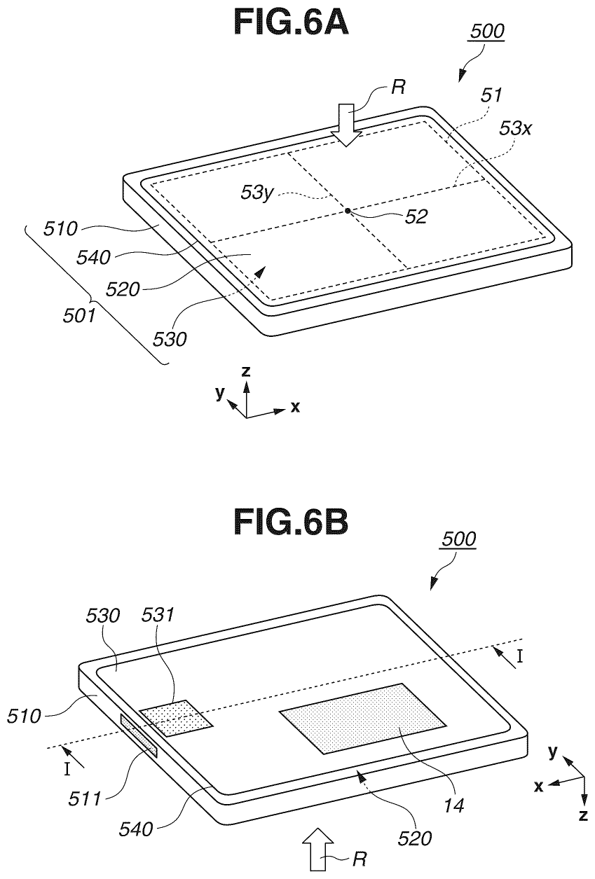

FIG. 6A is a diagram illustrating a radiographic apparatus 500, which is an example of the apparatus, as viewed from a radiation incident surface portion where radiation R is incident. As illustrated in FIG. 6A, the radiographic apparatus 500 includes an exterior unit 501. This exterior unit 501 includes a radiation-transmitting plate 520, a rear housing 530, a frame 510, and bonding resins 540. The radiation-transmitting plate 520 constitutes the radiation incident surface portion mentioned above, and transmits the radiation R. The rear housing 530 constitutes a rear portion opposed to the radiation-transmitting plate 520. The frame 510 is a frame-like member constituting a side surface portion located between the radiation-transmitting plate 520 and the rear housing 530.

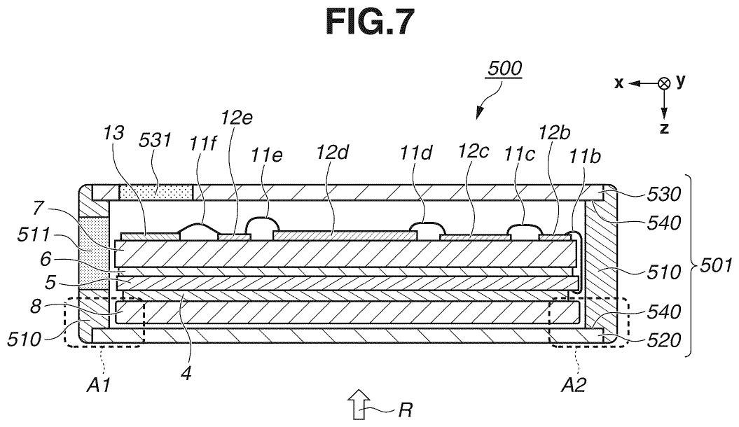

The alloy member 105 according to the first exemplary embodiment can be applied to the frame 510. Similarly, the member to be bonded 104 according to the first exemplary embodiment can be applied to the radiation-transmitting plate 520 and/or the rear housing 530. In FIG. 6A and FIGS. 6B and 7 to be described below, a bonding resin 540 is interposed between the frame 510 and the radiation-transmitting plate 520. The frame 510 and the radiation-transmitting plate 520 are bonded via the bonding resin 540. The radiation-transmitting plate 520 is an example of a plate-like member. A bonding resin 540 is interposed between the frame 510 and the rear housing 530. The frame 510 and the rear housing 530 are bonded via the bonding resin 540. The rear housing 530 is an example of the plate-like member.

FIG. 6B is a diagram illustrating the radiographic apparatus 500 as viewed from the rear portion opposed to the radiation incident surface portion where the radiation R is incident. In other words, FIG. 6B is a view of the radiographic apparatus 500 seen from the rear housing 530. In this FIG. 6B, a wireless radio wave-transmitting window 511 and a wireless radio wave-transmitting window 531 for enabling wireless communication are formed at predetermined positions on one of the side surfaces of the frame 510 and on the rear housing 530. FIG. 6B illustrates a power supply 14 accommodated in the exterior unit 501.

The exterior unit 501 of the radiographic apparatus 500 is desirably made of lightweight, high-strength materials.

Mg—Li alloys are suitable for the frame 510. The reason is that Mg—Li alloys are light in weight and have excellent damping properties and specific strength compared to lithium-free magnesium alloys. For the radiation-transmitting plate 520, a material having favorable transmittance for the incident radiation R is desirably selected. For example, CFRP, carbon, polyvinyl chloride, acrylic resin, polyester, and PMMA can be used for the radiation-transmitting plate 520. For the rear housing 530, Mg—Li alloys, Mg alloys, Al alloys, and CFRP can be used, for example. If the rear housing 530 is made of an Mg—Li alloy, the frame 510 and the rear housing 530 can be integrally formed. In such a case, the bonding resin 540 therebetween is not needed.

FIG. 7 is a diagram illustrating an example of the schematic configuration in section I-I of the radiographic apparatus 500 illustrated FIG. 6B. Components similar to those illustrated in FIGS. 6A and 6B are denoted by the same reference numerals, and a detailed description thereof will be omitted.

A phosphor layer 4 for converting the radiation R transmitted through an object into light is stacked inside the exterior unit 501 of the radiographic apparatus 500. The exterior unit 501 also includes a radiation detection unit 5 for converting the light occurring from the phosphor layer 4 into electrical signals. In other words, the phosphor layer 4 and the radiation detection unit 5 that are examples of parts are disposed in a space surrounded by the frame 510 and the radiation-transmitting plate 520 and/or rear housing 530 that are plate-like members. The phosphor layer 4 and the radiation detection unit 5 constitute a radiation detector for converting the radiation R transmitted through the object into the electrical signals. The radiation detection unit 5 is attached to a sensor holding plate 7 via a radiation shielding member 6. Typically, GOS (Gd₂O₂S) or CsI is often used as the material of the phosphor layer 4.

The radiation detection unit 5 is typically formed using a glass substrate, and can crack when undergoing a strong impact, high load, or large displacement. An impact absorption member 8 for absorbing impact is thus disposed on the radiation incident surface of the radiation detection unit 5 in the radiographic apparatus 500. To guide the radiation R transmitted through the object to the phosphor layer 4 with as little attenuation as possible, a material having high radiation transmittance needs to be selected for the impact absorption member 8. The radiation shielding member 6 has a function of protecting electric substrates 12 (12b to 12e), or the like, from the radiation R transmitted through the object and the radiation detection unit 5. The radiation shielding member 6 also has a function of preventing the radiation R that is transmitted through the radiographic apparatus 500 and scattered by the wall behind, or the like, from rebounding and entering the phosphor layer 4 and the radiation detection unit 5 again. For that purpose, materials such as Mo, W, Pb, Al, Cu, stainless steel (SUS), and barium sulfate are often used as the material of the radiation shielding member 6. Sheet members compounded with these materials may be used.

Electric substrates for reading the electrical signals converted by the radiation detection unit 5 via wiring 11b, electric substrates and communication module substrates for generating image data on a radiographic image after the reading of the electrical signals, an antenna 13 for wireless communication, and the like, are disposed on the surface of the sensor holding plate 7 closer to the rear housing 530.

If the exterior unit 501 is made of metal-based materials, wireless radio waves for establishing a wireless communication connection may be shielded. The exterior unit 501 is therefore provided with the wireless radio wave-transmitting windows 511 and 531 as illustrated in FIG. 7. Considering wireless radiation characteristics, the antenna 13 is located near the wireless radio wave-transmitting windows 511 and 531. The wireless radio wave-transmitting windows 511 and 531 may be integrated to cover the adjoining sides of the exterior unit 501.

Since the bonded body 100 according to the first exemplary embodiment has excellent adhesive strength, the adhesion area can be reduced compared to heretofore. A smaller and lighter radiographic apparatus 500 with a reduced frame width can thus be provided by bonding the frame 510 to the radiation-transmitting plate 520 and/or the rear housing 530 using the bonding resin(s) 540, for example. The bonded body according to the first exemplary embodiment can be used for not only the exterior unit 501 but the sensor holding plate 7 as well.

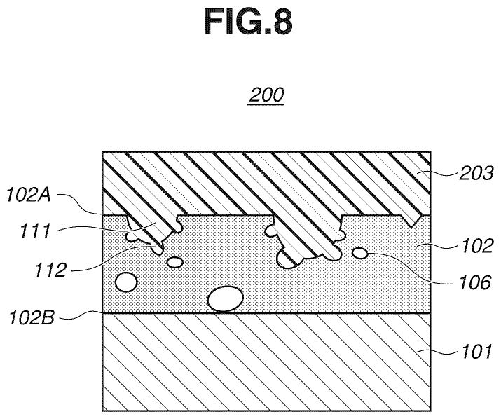

FIG. 8 is a schematic diagram illustrating an alloy member according to a second exemplary embodiment, a sectional view taken along the stacking direction. An alloy member 200 includes a base 101, an anti-corrosion film 102 disposed on the base 101, and a resin film 203 that is a cured resin article disposed on the anti-corrosion film 102. The alloy member 200 according to the second exemplary embodiment differs from the bonded body 100 according to the first exemplary embodiment in that the bonding resin 103 and the member to be bonded 104 are not included and that the resin film 203 is included.

The application of the alloy member 200 is not limited in particular. For example, the alloy member 200 can be used as structures depending on the user's intended use, such as exterior members (housings), interior members, and sliding members of equipment including parts.

Components similar to those illustrated in FIG. 1 are hereinafter denoted by the same reference numerals, and a detailed description thereof will be omitted.

### (Resin Film)

The resin film 203 is a coating film such as a primer and an overcoat. Examples of the coating film include heat-shielding films having heat-shielding functions, sliding films having abrasion resistance, light-shielding films having light-shielding and light-absorbing performance, and weatherproof films for extending the service life of equipment and devices.

Like the bonding resin 103 of the bonded body 100 according to the first exemplary embodiment, a part of the resin film 203 is located in the first recesses 111 and the second recesses 112, whereby the adhesion between the anti-corrosion film 102 and the resin film 203 is improved. The alloy member 200 including the resin film 203 thus has excellent adhesion of the resin film 203. The reason is that the uncured resin material, or the precursor of the resin film 203, placed on the anti-corrosion film 102 enters the first recesses 111 and the second recesses 112 and cures there. In other words, the resin film 203 is in contact with the non-recess region 102AA of the surface 102A, the surfaces 111A of the first recesses 111, and the surfaces 112A of the second recesses 112. Since the alloy member 200 has the second recesses 112, the contact area between the anti-corrosion film 102 and the resin film 203 increases compared to without the second recesses 112. As a result, the adhesion between the anti-corrosion film 102 and the resin film 203 is higher than in an alloy member without the second recesses 112.

The material of the resin film 203 is not limited in particular. Examples include urethane resins and epoxy resins. The uncured resin material that is the precursor of the resin film 203 has a viscosity in the range of 0.01 Pa·s or more and 0.1 Pa·s or less.

The resin film 203 desirably has an elastic modulus in the range of 0.1 GPa or more and 15 GPa or less. The elastic modulus in this range absorbs impact and makes the resin film 203 and the anti-corrosion film 102 less likely to exfoliate from each other even when the alloy member 200 falls. A more desirable range of the elastic modulus is 0.2 GPa or more and 5 GPa or less.

The resin film 203 desirably has a thickness in the range of 3 μm or more and 150 μm or less. Such a thickness absorbs impact and makes the resin film 203 and the anti-corrosion film 102 less likely to exfoliate from each other even when the alloy member 200 falls. A more desirable range of the thickness is 5 μm or more and 50 μm or less.

An example where the alloy member 200 according to the second exemplary embodiment is applied to an apparatus will be described. While an interchangeable lens and a single-lens reflex digital camera will be described below as an example, the apparatus is not limited thereto and may be a smartphone or a compact digital camera.

### [Optical Device and Imaging Apparatus]

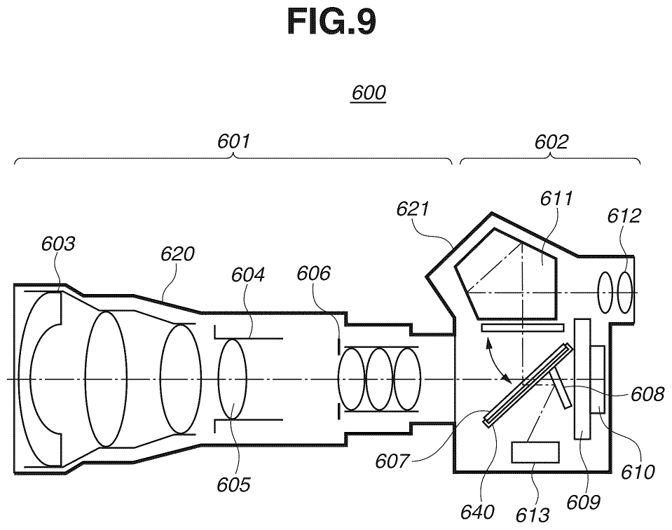

FIG. 9 illustrates a configuration of a single-lens reflex digital camera 600 that is an imaging apparatus as an example of the apparatus. In FIG. 9, a camera main body 602 and a lens barrel 601 that is an optical device are connected to each other. The lens barrel 601 is an interchangeable lens that can be detachably attached to the camera main body 602.

Light from an object passes through an optical system including a plurality of lenses 603 and 605 that is an example of parts arranged on the optical axis of an imaging optical system in the housing of the lens barrel 601. An image sensor 610 receives the light to capture an image. The lens 605 is movably supported by an inner barrel 604 relative to the outer barrel of the lens barrel 601 for the sake of focusing and zooming.

In an observation period before imaging, the light from the object is reflected at a main mirror 607 that is an example of a part in a housing 621 of the camera main body 602, transmitted through a prism 611, and then passed through a finder lens 612, whereby an image to be captured is displayed to the photographer. The main mirror 607 is configured as a half mirror, for example, and light transmitted through the main mirror 607 is reflected at a sub mirror 608 toward an autofocus (AF) unit 613. This reflected light is used for distance measurement, for example. The main mirror 607 is mounted and supported on a main mirror holder 640 by adhesive bonding. During imaging, the main mirror 607 and the sub mirror 608 are moved out of the optical path by a not-illustrated driving mechanism, and a shutter 609 is opened to form an imaging light image incident on the image sensor 610 from the lens barrel 601. A diagraph 606 is configured to be capable of adjusting the brightness and the depth of focus during imaging by changing the aperture area.

The alloy member 200 can be used for at least a part of housings 620 and 621. Here, the alloy member 200 is arranged so that the resin film 203 is located at least on a part of the outer peripheries of the housings 620 and 621. Since the alloy member 200 has excellent adhesion between the anti-corrosion film 102 and the resin film 203, a lightweight imaging apparatus with excellent adhesion strength of the resin film 203 can be provided compared to conventional imaging apparatuses.

Now, the present exemplary embodiment will be more specifically described in conjunction with practical examples. The present disclosure is not limited to the following examples.

### [Manufacturing of Alloy Member]

Example 1 will be described. A base made of an Mg—Li alloy to serve as an anode of the anodization apparatus was prepared. Ares (composition: Mg-9% Li-4% Al-1% Zn, manufactured by Amli Materials Technology Co., Ltd.) cylindrical billets (90 mm in bottom diameter, 300 mm in length) were prepared as the raw material. The cylindrical billets were set in a material feeder of a dicast molding machine (LMI450 manufactured by Sodic Co., Ltd.), pushed into the melting cylinder, and melted. The molten metal was supplied to the injection cylinder and then rapidly extruded into the mold by the injection plunger. The molding conditions were a mold temperature of 200° C. and an injection speed of 2000 mm/s in the molding machine. A portion of the molded article solidified in the mold was cut into a rectangular solid shape of 40 mm×14 mm×4 mm in size, and each face of the rectangular solid was lapped to produce a base 101 of example 1.

An anode and a cathode were placed in the electrolyte solution 401. The anode was the foregoing base 101. The electrolyte solution 401 was prepared by adding pure water to 4600 g of ammonium fluoride and 1900 g of triammonium phosphate trihydrate so that the mixture resulted in a volume of 20 liters when completely dissolved. The content ratio of fluorine ions in this electrolyte solution was 6.2 mol/L, the content ratio of phosphate ions was 0.47 mol/L, and the content ratio of ammonium ions was 7.6 mol/L. The electrolyte solution 401 was poured into the outer tank 402 of the anodization apparatus 400 illustrated in FIG. 5, and the magnet pump 405 was activated. After the solution overflowed from the inner tank 403 and started to be circulated, the temperature adjustment mechanism 404 was activated to stabilize the solution temperature at 20° C. A carbon plate serving as the cathode was then immersed and placed in the inner tank 403, and connected to the cathode of the direct-current stabilized power supply 410 with a conductive wire.

A voltage was applied across the anode and the cathode to form an anti-corrosion film 102, whereby an alloy member 105 was obtained.

Specifically, a conductive holding jig (hereinafter, may be referred to as a conductive substrate holding jig) 409 made of AZ31 material was prepared. The conductive substrate holding jig 409 had a fixed hinge at the end of an AZ31 round rod, with a movable hinge at a position of 107 mm from the fixed hinge. The fixed hinge and the movable hinge were configured to be contracted by a Viton O-ring. This conductive substrate holding jig 409 was anodized in the electrolyte solution in advance until no current flowed at a voltage of 140 V. This treatment facilitates power transmission to the conductive substrate holding jig 409. The base 101 to be anodized was clamped in the pre-treated conductive substrate holding jig 409, connected to the anode of the direct-current stabilized power supply 410 with a conductive wire, and immersed and placed in the inner tank 403 at a position opposed to the cathode. PAT160-100TMX manufactured by KIKUSUI Electronics Corp. was used as the direct-current stabilized power supply 410. The input current was 0.78 A (surface area: 15.5 cm², current density: 5 A/100 cm²). The target thickness was 45 μm, and the input charge was set to 408 C. The current from the direct-current stabilized power supply 410 was stopped when the specified coulomb amount was reached.

The anodized base and the conductive substrate holding jig 409 were taken out from the inner tank 403, and washed with pure water to thoroughly rinse off the electrolyte solution 401 adhering to the surface. The base was then dried at 60° C. in a clean oven, whereby an alloy member 105 of example 1 was obtained. The thickness of the anti-corrosion film 102 was 47.4 μm.

### [Manufacturing of Bonded Body]

Two alloy members 105 of example 1 were prepared. An adhesive (product name: epoxy two-component strong adhesive, manufactured by Daiso Industries Co., Ltd.) was applied to the surface 102A (with a size of 40 mm×14 mm in a plan view) of the anti-corrosion film 102 of one of the alloy members 105 and the surfaces 111A of the first recesses 111. The main component of the adhesive was epoxy resin, and the curing agent was modified amine. The main component and curing agent of the adhesive were thoroughly mixed, and 0.5 ml of the mixture was applied. The other alloy member 105 was used as the member to be bonded 104. The member to be bonded 104 was laminated on and pressed against the adhesive-applied alloy member 105. The article was then cured at 60° in a clean oven, whereby a bonded body 100 of example 1 was obtained.

Examples 2 to 5 and comparative examples 1 to 3 differ from example 1 in that the electrolyte solution was prepared to have the fluorine ion ratios listed in Table 1 by changing the content of ammonium fluoride and triammonium phosphate trihydrate. In other respects, alloy members and bonded bodies were manufactured using the same procedure as in example 1.

TABLE 1

| | | | | (A) | (B) | |
|---|---|---|---|---|---|---|
| | Ammonium | Ammonium | Ammonium | Fluorine | Phosphate | Fluorine |
| | fluoride | phosphate | ion | ion | ion | ion ratio |
| | [g/L] | [g/L] | [mol/L] | [mol/L] | [mol/L] | [A/(A + B)] |
| Example 1 | 230 | 95 | 7.61 | 6.21 | 0.47 | 93% |
| Example 2 | 377.2 | 34.2 | 10.69 | 10.18 | 0.17 | 98.4% |
| Example 3 | 345 | 47.5 | 10.02 | 9.32 | 0.23 | 97.6% |
| Example 4 | 184 | 114 | 6.65 | 4.97 | 0.56 | 89.9% |
| Example 5 | 414 | 19 | 11.46 | 11.18 | 0.09 | 99.2% |
| Comparative | 460 | 0 | 12.42 | 12.42 | 0.00 | 100% |
| example 1 | | | | | | |
| Comparative | 92 | 152 | 4.73 | 2.48 | 0.75 | 76.8% |
| example 2 | | | | | | |
| Comparative | 0 | 190 | 2.81 | 0 | 0.94 | 0% |
| example 3 | | | | | | |

### [Evaluation of Alloy Members]

The alloy members according to the examples and comparative examples were measured for the ratio of presence of first recesses 111 in the surface 102A of each anti-corrosion film 102. The measurement method included obtaining an SEM image at a magnification of 50 times, measuring five 1-mm² fields of view in the obtained SEM image for the number of first recesses 111 having an opening diameter T, and determining the average as the ratio of presence. The SEM image was obtained using Sigma 500 VP (field emission SEM [FE-SEM]) manufactured by Carl Zeiss Aktiengesellschaft (AG). The number of hole-like second recesses 112 that were located in the side surfaces of the first recesses 111 and observable from the surface 102A side of the anti-corrosion film 102 was counted by visual inspection.

### [Evaluation of Bonded Bodies]

### <Adhesion Force>

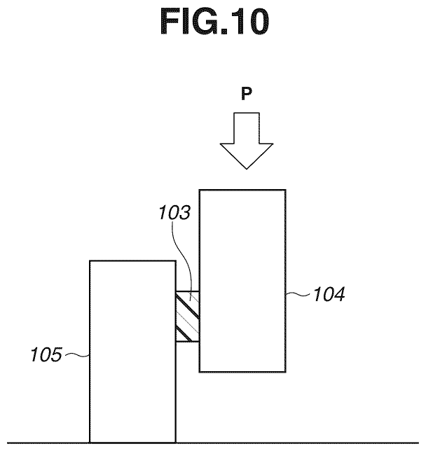

The bonded bodies 100 according to the examples and comparative examples were evaluated for adhesion force. The evaluation method will be described with reference to FIG. 10. The alloy member 105 of the bonded body 100 of example 1 was fixed at one side. A load P was applied to the non-fixed member to be bonded 104 in a direction parallel to the adhesive surface of the bonding resin 103. The load P and displacement were measured from the initial stage of application of the load P until the adhesive surface fractured. The bonded bodies 100 of the other examples and the comparative examples were measured in a similar manner.

The maximum value of the load P was multiplied by the displacement. The resulting values of 8.0 MPa·mm or more were evaluated as A, 5.0 MPa·mm or more and 8.0 MPa·mm or less as B, 4.5 MPa·mm or more and 5.0 MPa·mm or less as C, and less than 4.5 MPa·mm as D. Evaluations A, B, and C were determined to be acceptable.

### <Observation of Fracture Surfaces>

The fractured adhesive surfaces of the bonding resins 103 were observed under an FE-SEM (manufactured by Carl Zeiss AG) at magnifications of 30 to 3000 times.

Using the bonded bodies 100 fractured, an energy-dispersive X-ray spectroscopy (EDS) element analysis was conducted on the surfaces 102A of the anti-corrosion films 102 under Sigma 500 VP (FE-SEM) (manufactured by Carl Zeiss AG) at a magnification of 3000 times.

Table 2 lists the fluorine ion ratios, the ratios of presence of the first recesses 111, and the evaluations of the adhesion force.

TABLE 2

| | Fluorine ion | Ratio of presence of | |
|---|---|---|---|
| | ratio | first recesses | Evaluation of |
| | [A/(A + B)] | [/mm²] | adhesion force |
| Example 1 | 93% | 22.3 | A |
| Example 2 | 98.4% | 32.3 | A |
| Example 3 | 97.6% | 43.3 | A |
| Example 4 | 89.9% | 14.0 | B |
| Example 5 | 99.2% | 4.3 | C |
| Comparative | 100% | 0 | D |
| example 1 | | | |
| Comparative | 76.8% | 0 | D |
| example 2 | | | |
| Comparative | 0% | 0 | D |
| example 3 | | | |

From Table 2, it was found that examples 1 to 5 with the content ratio of fluorine ions in the range of 88% or more and 99.5% or less demonstrated sufficient adhesion force. By contrast, comparative examples 1 to 3 with the content ratio of fluorine ions not satisfying the foregoing range showed insufficient adhesion force.

Although not included in Table 2, the number of second recesses 112 in example 1 varied depending on the size of the first recess 111, with a minimum of 5, a maximum of 33, and an average of 13. In the other examples, the number of second recesses 112 also ranged between a minimum of 5 and a maximum of 33.

The fracture surface of the anti-corrosion film 102 of example 2 was subjected to an element analysis at a magnification of 3000 times. FIGS. 12A to 12F are SEM-EDS images of the surface 102A of the anti-corrosion film 102 in example 2. The elements targeted for the EDS element analysis were Mg, P, F, O, and C. FIG. 12A illustrates an SEM image of the composition. The images illustrated in FIGS. 12B to 12F display the relative abundance of each element in order of Mg, P, F, O, and C. The higher the relative abundance of each element, the whiter it is displayed. The lower, the blacker. The analysis conditions were an acceleration voltage of 10 kV and a work distance of 8.0 mm to 8.5 mm. A flat surface 301 in the SEM image is the fracture surface where the anti-corrosion film 102 was broken. Spherical roughened surfaces 302 are the surfaces of the first and second recesses 111 and 112. From the result of the EDS analysis, it was found that the roughened surfaces 302, or the surfaces of the first and second recesses 111 and 112, had a higher F concentration than in other regions. Moreover, an organic layer 303 containing C components derived from the adhesive was observed on the surfaces contacting the roughened surfaces 302. This confirms that the outermost surfaces of the first and second recesses 111 and 112 are fluoride layers. From this, it is considered that the adhesive permeated deeper and cured and solidified there due to the non-sticking (fluid repellant) effect of fluorine. This suggests that the adhesive penetrated into more complex shapes, and the adhesion force improved due to the ‘barb effect’. The observed area was the central part in the cross-sectional direction of the anti-corrosion film 102, and it was found that the adhesive penetrated up to a depth of 20 μm in the cross-sectional direction of the anti-corrosion film 102 from the surface where the adhesive was applied.

It was found that the adhesive strength can be improved by the provision of the first and second recesses 111 and 112.

### INDUSTRIAL APPLICABILITY

An alloy member and a bonded body according to an exemplary embodiment of the present disclosure can be used as structures of medical devices such as a radiographic apparatus, and optical devices such as a lens barrel and a camera main body. The alloy member and the bonded body can also be used as structures of various electronic devices including a personal computer, moving bodies such as a drone, or other industrial equipment.

The present disclosure includes the following items.

### (Item 1)

An alloy member including
a base containing magnesium and lithium, and
an anti-corrosion film disposed on the base, the anti-corrosion film containing magnesium, phosphorus, and fluorine,
wherein the anti-corrosion film includes at least one first recess in a surface on a side opposite the base, and
wherein a surface of the first recess includes at least one second recess smaller than the first recess.

### (Item 2)

The alloy member according to item 1, wherein the first recess has an average equivalent circle diameter of 30 μm or more.

### (Item 3)

The alloy member according to item 1 or 2, wherein the second recess has an average equivalent circle diameter of 10 μm or less.

### (Item 4)

The alloy member according to any one of items 1 to 3, wherein a first normal to an imaginary plane filling the first recess and a second normal to an imaginary plane filling the second recess intersect with each other.

### (Item 5)

The alloy member according to any one of items 1 to 4, wherein a distance between adjacent first recesses is greater than or equal to the average equivalent circle diameter of each of the adjacent first recesses.

### (Item 6)

The alloy member according to any one of items 1 to 5, wherein a content ratio of fluorine on the surface of the first recess and a surface of the second recess is higher than in a region of the surface of the anti-corrosion film other than the first and second recesses.

### (Item 7)

The alloy member according to any one of items 1 to 6, wherein the anti-corrosion film has a thickness of 20 μm or more.

### (Item 8)

The alloy member according to any one of items 1 to 7, wherein a sum of content of the magnesium and content of the lithium in the base is 90 mass % or more.

### (Item 9)

The alloy member according to item 8, wherein the content of the lithium in the base is in a range of 0.5 mass % or more and 15 mass % or less.

### (Item 10)

The alloy member according to item 9, wherein the content of the lithium in the base is in a range of 5 mass % or more and 11 mass % or less.

### (Item 11)

The alloy member according to any one of items 8 to 10,
wherein the base contains aluminum, and
wherein content of the aluminum in the base is in a range of 1 mass % or more and 8 mass % or less.

### (Item 12)

The alloy member according to any one of items 8 o 11,
wherein the base contains germanium and/or beryllium, and
wherein content of the germanium and/or beryllium in the base is in a range of 0.02 mass % or more and 0.4 mass % or less.

### (Item 13)

The alloy member according to item 12, wherein the content of the germanium in the base is in a range of 0.04 mass % or more and 0.4 mass % or less, and the content of the beryllium in the base is in a range of 0.02 mass % or more and 0.1 mass % or less.

### (Item 14)

The alloy member according to any one of items 8 to 13,
wherein the base contains zirconium, and
wherein content of the zirconium in the base is 0.6 mass % or more and 3.0 mass % or less.

### (Item 15)

The alloy member according to any one of items 8 to 14,
wherein the base contains at least one element selected from a group consisting of zinc, calcium, silicon, and manganese, and
wherein a total content of the group of elements in the base is 0.01 mass % or more and 5 mass % or less.

### (Item 16)

The alloy member according to item 15,
wherein the content of the zinc is 3 mass % or less,
wherein the content of the calcium is 3 mass % or less,
wherein the content of the silicon is 0.2 mass % or less,
wherein the content of the manganese is 0.5 mass % or less, and
wherein a remainder is incidental impurities and the magnesium.

### (Item 17)

The alloy member according to any one of items 1 to 16, further including a resin film on the anti-corrosion film.

### (Item 18)

A bonded body including
the alloy member according to any one of items 1 to 16,
a member to be bonded, and
a bonding resin configured to bond the alloy member and the member to be bonded,
wherein a part of the bonding resin is located in the first recess and the second recess.

### (Item 19)

The bonded body according to item 18,
wherein the alloy member is a frame-like member, and
wherein the member to be bonded is a plate-like member.

### (Item 20)

An apparatus including
the bonded body according to item 19, and
a part,
wherein the part is disposed in a space surrounded by the frame-like member and the plate-like member.

### (Item 21)

An apparatus including
a housing, and
a part accommodated in the housing,
wherein the housing includes the alloy member according to item 17, and
wherein the resin film is disposed on at least a part of an outer periphery of the housing.

### (Item 22)

A method for manufacturing an alloy member, the method including
placing an anode and a cathode in an electrolyte solution, and
applying a voltage across the anode and the cathode to form an anti-corrosion film on the anode,
wherein the anode contains magnesium and lithium,
wherein the electrolyte solution contains fluorine, ammonium, and phosphorus, and
wherein a content ratio of fluorine ions to a total amount of phosphate ions and fluorine ions in the electrolyte solution is in a range of 88% or more and 99.5% or less.

### (Item 23)

The method for manufacturing an alloy member according to item 22, the method further including
placing an uncured resin material on the anti-corrosion film, and
curing the uncured resin material to form a resin film.

### (Item 24)

The method for manufacturing an alloy member according to item 23, wherein the uncured resin material has a viscosity in a range of 0.01 Pa·s or more and 0.1 Pa·s or less.

### (Item 25)

A method for manufacturing a bonded body for bonding an alloy member and a member to be bonded via an adhesive, the method including
preparing the alloy member using the method according to item 22,
placing the adhesive on the alloy member and/or the member to be bonded, and
curing the adhesive to form a bonding resin configured to bond the alloy member and the member to be bonded.

### (Item 26)

The method for manufacturing a bonded body according to item 25, wherein the adhesive has a viscosity in a range of 5 Pa·s or more and 100 Pa·s or less.

### (Item 27)

An anti-corrosion film containing magnesium, phosphorus, and fluorine, the anti-corrosion film including at least one first recess in a surface on a side opposite a base,
wherein a surface of the first recess includes at least one second recess smaller than the first recess.

According to the present disclosure, an alloy member with excellent adhesion to a resin film and a bonded body with excellent adhesion between its alloy member and bonding resin can be provided.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-086421, filed May 28, 2024, which is hereby incorporated by reference herein in its entirety.

What is claimed is:

1. An alloy member comprising:
a base containing magnesium and lithium; and
an anti-corrosion film disposed on the base, the anti-corrosion film containing magnesium, phosphorus, and fluorine,
wherein the anti-corrosion film includes at least one first recess in a surface on a side opposite the base, and
wherein a surface of the at least one first recess includes at least one second recess smaller than the at least one first recess.

2. The alloy member according to claim 1, wherein the at least one first recess has an average equivalent circle diameter of 30 μm or more.

3. The alloy member according to claim 1, wherein the at least one second recess has an average equivalent circle diameter of 10 μm or less.

4. The alloy member according to claim 1, wherein a first normal to an imaginary plane filling the at least one first recess and a second normal to an imaginary plane filling the at least one second recess intersect with each other.

5. The alloy member according to claim 1,
wherein the at least one first recess includes adjacent first recesses, and
wherein a distance between the adjacent first recesses is greater than or equal to the average equivalent circle diameter of each of the adjacent first recesses.

6. The alloy member according to claim 1, wherein a content ratio of fluorine on the surface of the at least one first recess and a surface of the at least one second recess is higher than that in a region of the surface of the anti-corrosion film other than the at least one first recess and the at least one second recess.

7. The alloy member according to claim 1, wherein the anti-corrosion film has a thickness of 20 μm or more.

8. The alloy member according to claim 1, wherein a sum of content of the magnesium and content of the lithium in the base is 90 mass % or more.

9. The alloy member according to claim 8, wherein the content of the lithium in the base is 0.5 mass % or more and 15 mass % or less.

10. The alloy member according to claim 9, wherein the content of the lithium in the base is 5 mass % or more and 11 mass % or less.

11. The alloy member according to claim 8,
wherein the base contains aluminum, and
wherein content of the aluminum in the base is 1 mass % or more and 8 mass % or less.

12. The alloy member according to claim 8,
wherein the base contains germanium and/or beryllium, and
wherein content of the germanium and/or beryllium in the base is 0.02 mass % or more and 0.4 mass % or less.

13. The alloy member according to claim 12, wherein the content of the germanium in the base is 0.04 mass % or more and 0.4 mass % or less, and the content of the beryllium in the base is 0.02 mass % or more and 0.1 mass % or less.

14. The alloy member according to claim 8,
wherein the base contains zirconium, and
wherein content of the zirconium in the base is 0.6 mass % or more and 3.0 mass % or less.

15. The alloy member according to claim 8,
wherein the base contains at least one element selected from a group consisting of zinc, calcium, silicon, and manganese, and
wherein a total content of the group of elements in the base is 0.01 mass % or more and 5 mass % or less.

16. The alloy member according to claim 15,
wherein the content of the zinc is 3 mass % or less,
wherein the content of the calcium is 3 mass % or less,
wherein the content of the silicon is 0.2 mass % or less,
wherein the content of the manganese is 0.5 mass % or less, and
wherein a remainder is incidental impurities and the magnesium.

17. The alloy member according to claim 1, further comprising a resin film on the anti-corrosion film.

18. A bonded body comprising:
the alloy member according to claim 1;
a member to be bonded; and
a bonding resin configured to bond the alloy member and the member to be bonded,
wherein a part of the bonding resin is located in the at least one first recess and the at least one second recess.

19. An apparatus comprising:
the bonded body according to claim 18, wherein the alloy member is a frame-like member and the member to be bonded is a plate-like member; and
a part,
wherein the part is disposed in a space surrounded by the frame-like member and the plate-like member.

20. An apparatus comprising:
a housing; and
a part accommodated in the housing,
wherein the housing includes the alloy member according to claim 17, and
wherein the resin film is disposed on at least a part of an outer periphery of the housing.

21. An anti-corrosion film containing magnesium, phosphorus, and fluorine, the anti-corrosion film comprising:
at least one first recess in a surface on a side opposite a base,
wherein a surface of the at least one first recess includes at least one second recess smaller than the at least one first recess.
